(19) United States
(12) Patent Application Publication
(10) Pub. No.: US 2018/0253219 A1
(43) Pub. Date: Sep. 6, 2018

(54) PERSONALIZED PRESENTATION OF CONTENT ON A COMPUTING DEVICE

(71) Applicant: MICROSOFT TECHNOLOGY LICENSING, LLC, Redmond, WA (US)

(72) Inventors: DIKLA DOTAN-COHEN, HERZLIYA (IL); IDO PRINESS, HERZLIYA (IL); HAIM SOMECH, HERZLIYA (IL)

(21) Appl. No.: 15/450,475

(22) Filed: Mar. 6, 2017

(51) Int. Cl. G06F 3/0484

(52) U.S. Cl. CPC G06F 3/04847

(57) ABSTRACT

Technology is disclosed for providing user control over content presented on personal computing devices (i.e., user devices). A current context associated with a user device is determined, and a set of personalized metadata characterizing content items is received. Based on the current context associated with the user device, and the set of personalized metadata, instructions may be generated to modify the presentation of any content, such as by concealing or revealing certain content items.

### BACKGROUND

Personal computing devices, such as smartphones, now carry and display a great variety of information, including, for example, documents, links, pictures, email, conversations (such as texts), applications, programs, music, or calendar appointments. However, there may be situations and contexts where it would be advantageous to conceal certain information, and to do so in a way that does not indicate information was concealed. Conversely, there may be other situations and contexts where it would be advantageous to reveal or present certain information, possibly in a highlighted manner.

In some devices, it may be possible to either hide all information, or reveal all information. This is a one-size-fits-all approach. Or the user may manually delete certain information he/she does not want to reveal on an item-by-item basis. But this approach might delete information the user would rather keep for later use. Or the user may simply choose not to utilize the device if he/she does not wish to reveal some information. But, in this approach, the user loses the ability to use his device. In addition, these approaches may require careful attention of the user to his or her “context” at any time, as well as manual adaptation of the displayed items.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are directed towards technologies for improving information, and user control over the information, presented on personal computing devices (sometimes referred to herein as mobile devices or user devices). In particular, embodiments provide technology to selectively conceal, or reveal, information on a user device based upon a current context associated with the user device, a set of personalized metadata characterizing one or more content items presentable on the user device, and presentation logic. The presentation logic includes a set of rules that specify criteria for controlling the presentation of a content item. The presentation logic might include, for example, concealing the content item, highlighting the content item, surfacing additional content items, positioning the content item, prioritizing the content item, or substituting one content item for a different content item.

### BRIEF DESCRIPTION OF THE DRAWINGS

Aspects of the disclosure are described in detail below with reference to the attached drawing figures, wherein:

FIG. 1 is a block diagram of an example operating environment suitable for implementations of the present disclosure;

FIG. 2 is a diagram depicting an example computing architecture suitable for implementing aspects of the present disclosure;

FIGS. 3A-C illustratively depict exemplary screenshots from a personal computing device showing aspects of example graphical user interfaces, in accordance with an embodiment of the present disclosure;

FIG. 4 depicts a flow diagram of a method for providing implementations of presentation logic on a user device, in accordance with an embodiment of the present disclosure; and

FIG. 5 is a block diagram of an exemplary computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

Aspects of the present disclosure relate to technology for facilitating and improving information, and user control over the information, presented on personal computing devices (sometimes referred to herein as mobile devices or user devices). The coalescence of telecommunications and personal computing technologies in the modern era has enabled, for the first time in human history, information on demand combined with a ubiquity of personal computing resources (including mobile personal computing devices and cloud-computing coupled with communication networks). As a result, it is increasingly common for users to rely on one or more mobile computing devices throughout the day for handling various tasks. But these user devices are almost constantly with the user, and may display certain information that can be seen by others nearby. As such, the progression of these technologies has elevated concerns about user privacy, and what information should be seen by others. These technologies, as described below, also now offer the opportunity to present information desired for display or relevant to a user's context, and to conceal or hide other information that is not desired for display, or is not relevant to the user's context.

Many users desire—at least at certain times or for certain situations—to have greater control over how this personal computing technology displays or presents information. But conventional approaches to displaying information—such as hiding all open applications, manually deleting information, or simply leaving the entire device hidden—do not really address the issues and opportunities created by these technologies. In particular, among other benefits, embodiments described herein improve technology by enabling users to continue to enjoy the benefit of their user devices, but to have information presented in a more beneficial manner, such as by automatically selectively displaying and/or highlighting information desired by the user, or indicated as beneficial or more relevant by the user's context, or by concealing information the user does not wish to display, or that is indicated less desirable or less relevant by the user's context. As information is presented, the fact that the displayed information has been brought to the forefront, or that other information has been concealed, is not apparent from the presentation of information. This information could be any of a broad variety of information that is displayable on a user device, including, but not limited to, documents, links, search history, images (pictures), icons, folders, emails, conversation records (such as text messages), notifications, applications, programs, or games.

Accordingly, solutions provided herein include technologies for improving, or providing improved control over, the presentation or display of information on computing devices. In particular, some of these technologies reveal (present) or conceal information based upon a user's context, the nature of the information itself, and rules or logic indicating what information is likely desired by the user for presentation, or concealment, given the user's context and the nature of the information. The display may be managed to obfuscate the fact that only certain information is revealed, and that other information is concealed. The user's context data may include, for example and without limitation, location data (e.g., the location of the mobile device or location history), which may include venue information; application (or “app”) usage; app installation; communication such as incoming or outgoing calls, texts, emails, and instant messages; user searches or search history; motion information such as accelerometric/gyroscopic information or motion derived from sensing changes in location information; physiological information (e.g., blood pressure or heart rate, which may be provided from a wearable mobile computing device); information characterizing a state or usage of the device, such as whether the device is likely being used by the owner or another person (such as a child) whether the device is lost or stolen, or other information related to the user's current or historic activity that is detectable or otherwise determinable via the user's mobile device. The nature of the information may include the type of information (such as, for example, a program, data, an application, category of program, data, or application, (e.g., a game program, a dating app, browsing history data), or a rating corresponding to the information (e.g., mature, not-safe-for-work, children)) as well as the actual content of the information (such as, for example, content of documents, emails, texts, or music). The rules or logic may include default parameters, parameters that are learned or inferred from the user or similar user, as well as settings and preferences that a user can selectively invoke, and may further include a user interface enabling a user to manage specific aspects of the display of information.

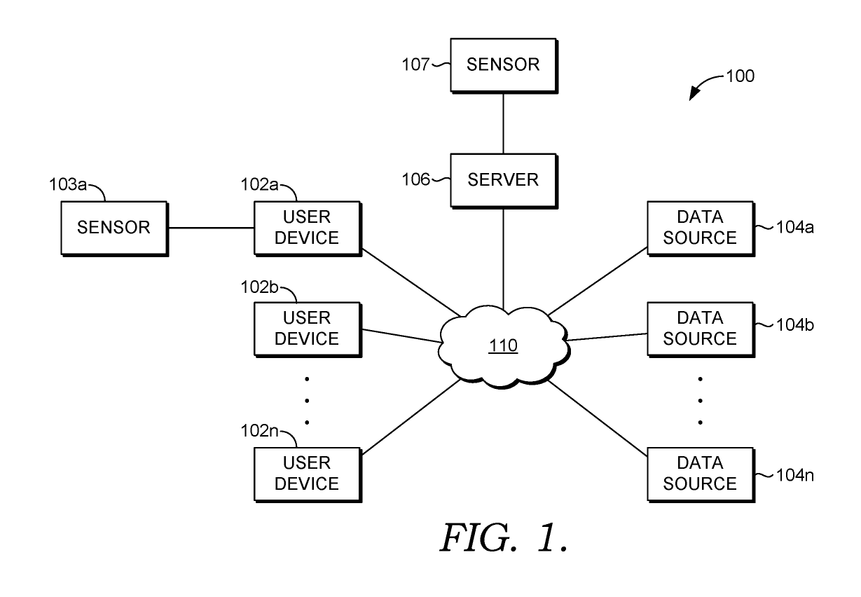

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

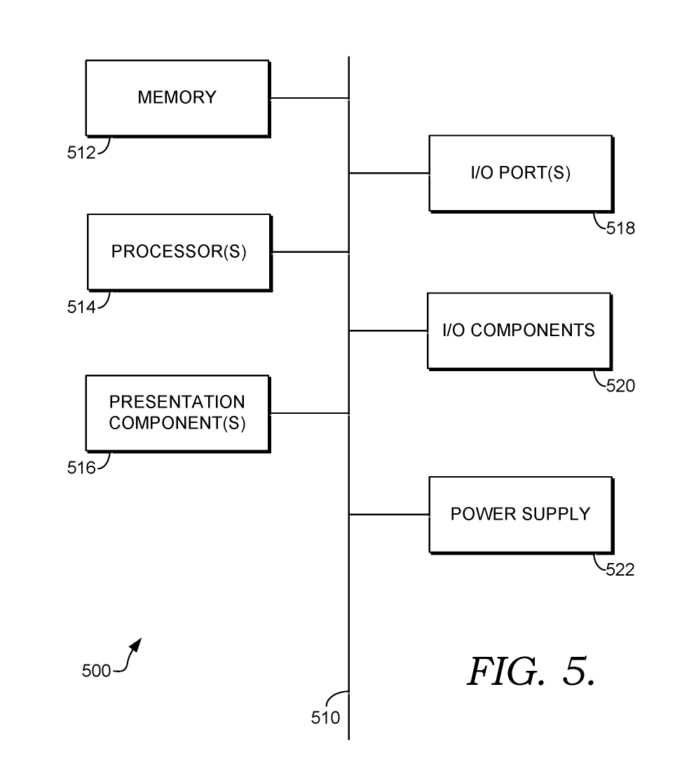

Among other components not shown, example operating environment 100 includes a number of user computing devices, such as user devices 102a and 102b through 102n; a number of data sources, such as data sources 104a and 104b through 104n; server 106; sensors 103a and 107; and network 110. It should be understood that environment 100 shown in FIG. 1 is an example of one suitable operating environment. Each of the components shown in FIG. 1 may be implemented via any type of computing device, such as computing device 500 described in connection to FIG. 5, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 5 herein. By way of example and not limitation, a user device may be embodied as a personal computer (PC), a laptop computer, a mobile or mobile device, a smartphone, a smart speaker, a tablet computer, a smart watch, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized meter or measuring device, an appliance, a consumer electronic device, a workstation, or any combination of these delineated devices, a combination of these devices, or any other suitable computer device.

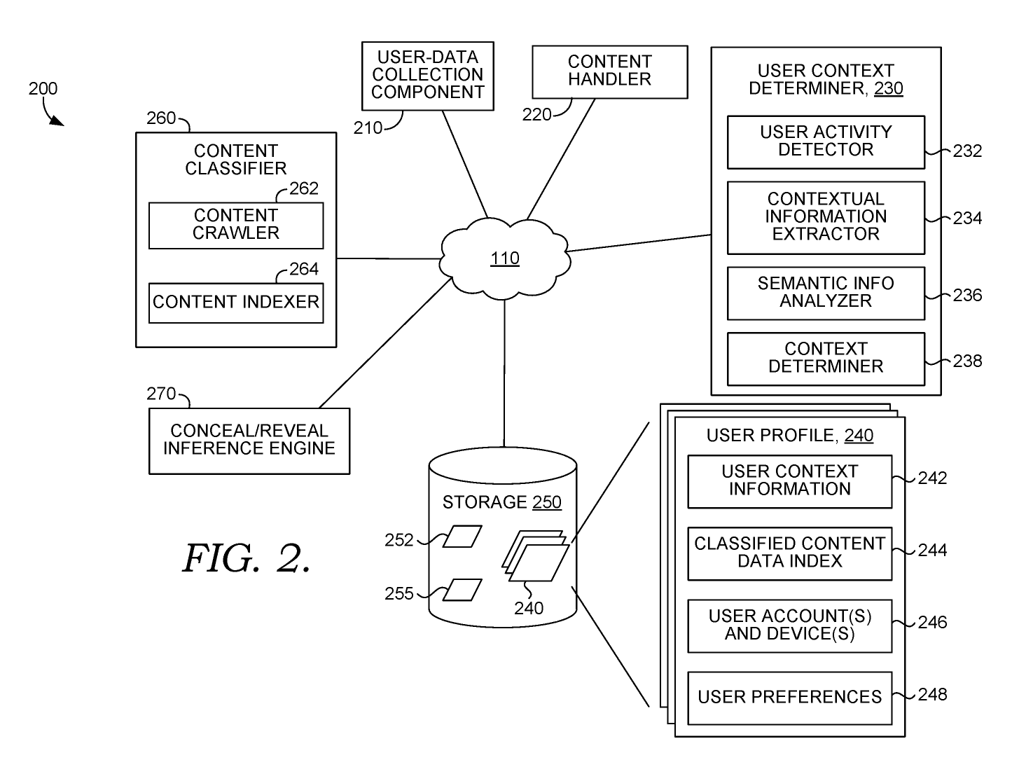

Data sources 104a and 104b through 104n may comprise data sources and/or data systems, which are configured to make data available to any of the various constituents of operating environment 100, or system 200 described in connection to FIG. 2. (For instance, in one embodiment, one or more data sources 104a through 104n provide (or make available for accessing) user data, which may include user-activity related data, to user-data collection component 210 of FIG. 2.) Data sources 104a and 104b through 104n may be discrete from user devices 102a and 102b through 102n and server 106 or may be incorporated and/or integrated into at least one of those components. In one embodiment, one or more of data sources 104a through 104n comprise one or more sensors, which may be integrated into or associated with one or more of the user device(s) 102a, 102b, or 102n or server 106. Examples of sensed user data made available by data sources 104a through 104n are described further in connection to user-data collection component 210 of FIG. 2.

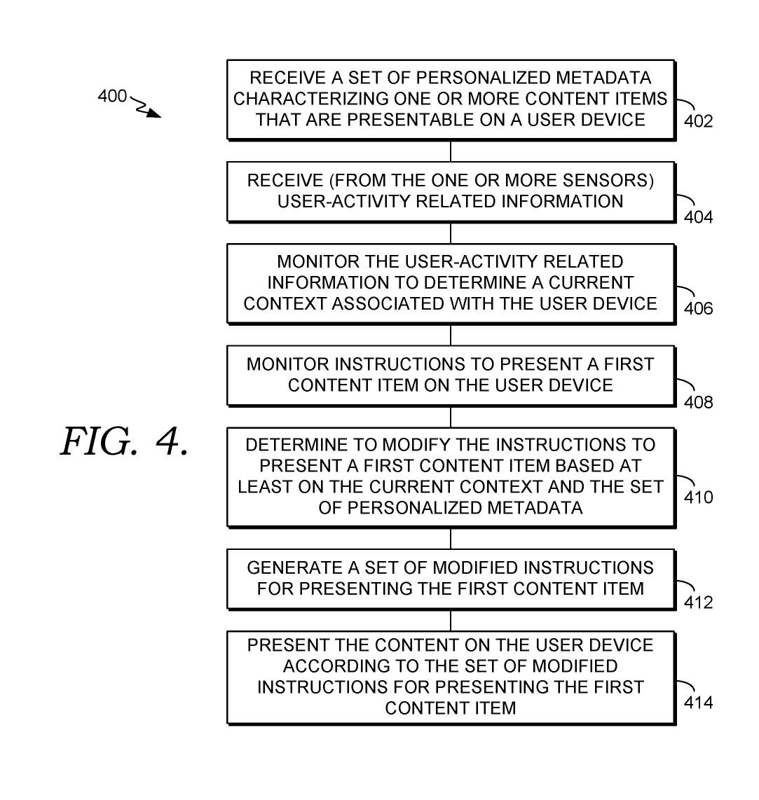

Operating environment 100 can be utilized to implement one or more of the components of system 200, described in FIG. 2, including components for collecting user data; monitoring or determining user tasks, user activity and events, user patterns (e.g., (usage, behavior, or activity patterns), user preferences, context data, or related information to facilitate sharing context or to otherwise provide an improved user experience; generating personalized content; and/or presenting notifications and related content to users. Operating environment 100 also can be utilized for implementing aspects of method 400 in FIG. 4.

Referring now to FIG. 2, with FIG. 1, a block diagram is provided showing aspects of an example computing system architecture suitable for implementing an embodiment of this disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including user-data collection component 210, content handler 220, user context determiner 230, storage 250, content classifier 260, and conceal/reveal inference engine 270. User-data collection component 210, content handler 220, user context determiner 230, storage 250, content classifier 260, and conceal/reveal inference engine 270 may be embodied as a set of compiled computer instructions or functions, program modules, computer software services, or an arrangement of processes carried out on one or more computer systems, such as computing device 500 described in connection to FIG. 5, for example.

In one embodiment, the functions performed by components of system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s) such as the operating system layer, application layer, or hardware layer of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), or Complex Programmable Logic Devices (CPLDs). Additionally, although functionality is described herein with regards to specific components shown in example system 200, it is contemplated that in some embodiments functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some embodiments, user-data collection component 210 may be employed to facilitate the accumulation of user data of a particular user (or in some cases, a plurality of users including crowdsourced data) for user activity detector 232 or more generally user context determiner 230. The data may be received (or accessed), and optionally accumulated, reformatted, and/or combined, by user-data collection component 210 and stored in one or more data stores such as storage 250, where it may be available to other components of system 200. For example, the user data may be stored in or associated with a user profile 240, as described herein. In some embodiments, any personally identifying data (i.e., user data that specifically identifies particular users) is either not uploaded or otherwise provided from the one or more data sources with user data, is not permanently stored, and/or is not made available to user context determiner 230.

User data may be received from a variety of sources where the data may be available in a variety of formats. For example, in some embodiments, user data received via user-data collection component 210 may be determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user data associated with communication events) including, in some embodiments, user activity that occurs over more than one user device, user history, session logs, application data, contacts data, calendar and schedule data, notification data, social-network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related application, a personal assistant application or service), home-sensor data, appliance data, global positioning system (GPS) data, vehicle signal data, traffic data, weather data (including forecasts), wearable device data, other user device data (which may include device settings, profiles, network-related information (e.g., network name or ID, domain information, workgroup information, connection data, Wi-Fi network data, or configuration data, data regarding the model number, firmware, or equipment, device pairings, such as where a user has a mobile phone paired with a Bluetooth headset, for example, or other network-related information), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein.

User data, particularly in the form of contextual information, can be received by user-data collection component 210 from one or more sensors and/or computing devices associated with a user. In some embodiments, user-data collection component 210, user context determiner 260 (or one or more of its subcomponents), or other components of system 200 may determine interpretive data from received user data. Interpretive data corresponds to data utilized by the components or subcomponents of system 200 that comprises an interpretation from processing raw data, such as venue information interpreted from raw location information. Interpretive data can be used to provide context to user data, which can support determinations or inferences carried out by components of system 200. Moreover, it is contemplated that some embodiments of the disclosure use user data alone or in combination with interpretive data for carrying out the objectives of the subcomponents described herein. It is also contemplated that some user data may be processed, by the sensors or other subcomponents of user-data collection component 210 not shown, such as for interpretability by user-data collection component 210. However, embodiments described herein do not limit the user data to processed data and may include raw data or a combination, as described above.

In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, or as needed.

User context determiner 230 is generally responsible for monitoring user data (such as that collected by user-data collection component 210) for information that may be used for determining user context, which may include features (sometimes referred to herein as “variables”) or other information regarding specific user actions and related contextual information. Embodiments of user context determiner 230 may determine, from the monitored user data, a user context associated with a particular user or user device. As described previously, the user context information determined by user context determiner 230 may include user information from multiple user devices associated with the user and/or from cloud-based services associated with the user (such as email, calendars, social media, or similar information sources), and which may include contextual information associated with the identified user activity (such as location, time, venue specific information, or other people present). User context determiner 230 may determine current or near-real-time user information and may also determine historical user information, in some embodiments, which may be determined based on gathering observations of a user over time. Further, in some embodiments, user context determiner 230 may determine user context from other similar users.

As described previously, user context features may be determined by monitoring user data received from user-data collection component 210. In some embodiments, the user data and/or information about the user context determined from the user data is stored in a user profile, such as user profile 240.

In an embodiment, user context determiner 230 comprises one or more applications or services that analyze information detected via one or more user devices used by the user and/or cloud-based services associated with the user, to determine user-related or user-device-related contextual information. Information about user devices associated with a user may be determined from the user data made available via user-data collection component 210, and may be provided to user context determiner 230 or conceal/reveal inference engine 270, or other components of system 200.

Some embodiments of user context determiner 230, or its subcomponents, may determine a device name or identification (device ID) for each device associated with a user. This information about the identified user devices associated with a user may be stored in a user profile associated with the user, such as in user accounts and devices 246 of user profile 240. In an embodiment, the user devices may be polled, interrogated, or otherwise analyzed to determine information about the devices. This information may be used for determining a label or identification of the device (e.g., a device ID) so that the user interaction with the device may be recognized by user context determiner 230. In some embodiments, users may declare or register a device, such as by logging into an account via the device, installing an application on the device, connecting to an online service that interrogates the device, or otherwise providing information about the device to an application or service. In some embodiments, devices that sign into an account associated with the user, such as a Microsoft® account or Net Passport, email account, social network, or the like, are identified and determined to be associated with the user.

User context determiner 230, in general, is responsible for determining (or identifying) contextual information about a user or user-device associated with a user. Embodiments of user activity detector 232 may be used for determining current user activity or one or more historical user actions. Some embodiments of user activity detector 232 may monitor user data for activity-related features or variables corresponding to user activity such as, for example, user location; indications of applications launched or accessed; files accessed, modified, or copied; websites navigated to; online content downloaded and rendered or played; or similar user activities.

Contextual information extractor 234, in general, is responsible for determining contextual information related to the user activity (detected by user activity detector 232 or user context determiner 230), such as context features or variables associated with user activity, related information, and user-related activity, and is further responsible for associating the determined contextual information with the detected user activity. In some embodiments, contextual information extractor 234 may associate the determined contextual information with the related user activity and may also log the contextual information with the associated user activity. Alternatively, the association or logging may be carried out by another service. For example, some embodiments of contextual information extractor 234 provide the extracted contextual information to context determiner 238, which determines user context using information from the user activity detector 232, the contextual information extractor 234, and/or the semantic information analyzer 236.

Some embodiments of contextual information extractor 234 determine contextual information related to a user action or activity event such as entities identified in a user activity or related to the activity (e.g., recipients of a group email sent by the user), which may include nicknames used by the user (e.g., “mom” and “dad” referring to specific entities who may be identified in the user's contacts by their actual names); information about the current user of the user device (e.g., whether the user is the owner or another user, the age of the current user, the relationship of the current user to the owner, such as a close friend, co-worker, family member, or unknown entity); or user activity associated with the location or venue of the user's device, which may include information about other users or people present at the location. By way of example and not limitation, this may include context features such as location data, which may be represented as a location stamp associated with the activity; contextual information about the location, such as venue information (e.g., this is the user's office location, home location, school, restaurant, move theater, or similar venue type information), yellow pages identifier (YPID) information, time, day, and/or date, which may be represented as a time stamp associated with the activity; user device characteristics or user device identification information regarding the device on which the user carried out the activity; duration of the user activity; other information about the activity such as entities associated with the activity (e.g., venues, people, objects), which may include people or objects in proximity to the user device, nicknames or personal expressions or terms used by (and in some instances created by) the user or acquaintances of the user (for example, a name for the venue that is specific to the user but not everyone, such as “Dikla's home,” “Haim's office,” “Ido's car,” “my Seattle friends”); information detected by sensor(s) on user devices associated with the user that is concurrent or substantially concurrent to the user activity (e.g., motion information or physiological information detected on a fitness tracking user device, listening to music, which may be detected via a microphone sensor if the source of the music is not a user device); or any other information related to the user activity that is detectable that may be used for determining patterns of user activity.

In some embodiments, a device name or identification (device ID) may be determined for each device associated with a user. This information about the identified user devices associated with a user may be stored in a user profile associated with the user, such as in user account(s) and device(s) 246 of user profile 240. In an embodiment, the user devices may be polled, interrogated, or otherwise analyzed to determine contextual information about the devices. This information may be used for determining information about a current user of a user device, or determining a label or identification of the device (e.g., a device ID) so that user activity on one user device may be recognized and distinguished from user activity on another user device. Further, as described previously, in some embodiments, users may declare or register a user device, such as by logging into an account via the device, installing an application on the device, connecting to an online service that interrogates the device, or otherwise providing information about the device to an application or service. In some embodiments devices that sign into an account associated with the user, such as a Microsoft® account or Net Passport, email account, social network, or the like, are identified and determined to be associated with the user.

In some implementations, contextual information extractor 234 may receive user data from user-data collection component 210, parse the data, in some instances, and identify and extract context features or variables (which may also be carried out by context determiner 238). Context variables may be stored as a related set of contextual information associated with the user activity, and may be stored in a user profile such as in user context information component 242. Contextual information also may be determined from the user data of one or more users, in some embodiments, which may be provided by user-data collection component 210 in lieu of or in addition to user activity information for the particular user.

Semantic information analyzer 236 is generally responsible for determining semantic information associated with the user-activity related features identified by user activity detector 232 or contextual information extractor 234. For example, while a user-activity feature may indicate a specific website visited by the user, semantic analysis may determine the category of website, related websites, themes or topics, or other entities associated with the website or user activity. Semantic information analyzer 236 may determine additional user-activity related features semantically related to the user activity, which may be used for further identifying user context.

In particular, as described previously, a semantic analysis is performed on the user activity information and/or the contextual information, to characterize aspects of the user action or activity event. For example, in some embodiments, activity features associated with an activity event may be classified or categorized (such as by type, time frame or location, work-related, home-related, themes, related entities, other user(s) (such as communication to or from another user) and/or relation of the other user to the user (e.g., family member, close friend, work acquaintance, boss, or the like), or other categories), or related features may be identified for use in determining a similarity or relational proximity to other user activity events, which may indicate a pattern. In some embodiments, semantic information analyzer 236 may utilize a semantic knowledge representation, such as a relational knowledge graph. Semantic information analyzer 236 may also utilize semantic analysis logic, including rules, conditions, or associations to determine semantic information related to the user activity. For example, a user activity event comprising an email sent to someone who works with the user may be characterized as a work-related activity.

Semantic information analyzer 236 may also be used to characterize contextual information, such as determining that a location associated with the activity corresponds to a hub or venue of the user (such as the user's home, work, gym, or the like) based on frequency of user visits. For example, the user's home hub may be determined (using semantic analysis logic) to be the location where the user spends most of her time between 8 PM and 6 AM. Similarly, the semantic analysis may determine the time of day that corresponds to working hours, lunch time, commute time, or other similar categories. Similarly, the semantic analysis may categorize the activity as being associated with work or home, based on other characteristics of the activity (e.g., a batch of online searches about chi-squared distribution that occurs during working hours at a location corresponding to the user's office may be determined to be work-related activity, whereas streaming a movie on Friday night at a location corresponding to the user's home may be determined to be home-related activity). In this way, the semantic analysis provided by semantic information analyzer 236 may provide other relevant features that may be used for determining user context.

Context determiner 238 is generally responsible for determining user context-related features (or variables) associated with the user, which may include the context of a user device associated with the user. Context features may be determined from information about a user activity, from related contextual information, and/or from semantic information. In some embodiments, context determiner 238 receives information from user activity detector 232, contextual information extractor 234, and/or semantic information analyzer 236 and analyzes the received information to determine a set of one or more features associated with the user's context.

Examples of user context-related features include, without limitation, location-related features, such as location of the user device(s) during the user activity, venue-related information associated with the location, or other location-related information; other users present at the venue or location; proximity of the user device(s) to the user-owner of the user device(s); time-related features, such as time(s) of day(s), day of week or month of the user activity; current-user-related features, which may include information about the current or recent user of the user-device, which may include information indicating a likelihood that the current user is not the user-device owner (or primary user), relationship of the current user to the primary user, age of the current user, or information regarding other people present with the current user; user device-related features, such as device type (e.g., desktop, tablet, mobile phone, fitness tracker, heart rate monitor), hardware properties or profiles, OS or firmware properties, device IDs or model numbers, battery or power-level information, network-related information (e.g., mac address, network name, IP address, domain, work group, information about other devices detected on the local network, router information, proxy or VPN information, other network connection information), position/motion/orientation-related information about the user device, network usage information, user account(s) accessed or otherwise used (such as device account(s), OS level account(s), or online/cloud-services related account(s) activity, such as Microsoft® account or Net Passport, online storage account(s), email, calendar, or social networking accounts), an indication that the user-device is missing or stolen, which maybe explicitly provided by a user via another user-device or inferred based on current user-activity or other user data; content-related features, such as online activity (e.g., searches, browsed websites, purchases, social networking activity, communications sent or received including social media posts); or any other features that may be detected or sensed and used for determining the user context.

Example system 200 also includes a content classifier 260 that is generally responsible for scanning or crawling and indexing, for example, content, which may include data, programs, applications, or information related to data, programs or applications (such as icons, thumbnail images, avatars, files, folders, or similar information) associated with a user account, user device(s), and/or storage (whether on a user device on stored remotely, such as in a data store in the cloud). More specifically, content classifier 260 includes, in some embodiments, a content crawler 262 and a content indexer 264. Content crawler 262 identifies user content and related information, as broadly defined above, as an input. Again, this content and information could be present on user device(s) or stored remotely. The information and content identified by content crawler 262 is accessed by, or passed to, a content indexer 264. In some embodiments, content indexer 264 creates a classified content data index associating metadata with the content. The metadata may include non-mutually exclusive classifications or labels for the content items found by content crawler 262. As one example, a content item may have metadata designating the content item as: work, a particular company (Company X), entertainment, personal, a particular project (Project Z), private, sensitive, or similar designations.

Content classifier 260 may access user preferences 248, which may have settings indicating which user devices and storage may be accessed by content crawler 262, and may also specify or include user-defined labels or categories to be used by content indexer 264. Content classifier 260 may also access user accounts and device 246 to identify online or cloud-based storage accounts, email, calendars, and similar sources of content to be classified. In some embodiments, content classifier 260 (or its subcomponents) uses classification logic 252 to determine classification of user content. Classification logic 252 may include rules, conditions, associations, classification models, or other criteria to identify and classify content. For example, in one embodiment, classification logic 252 may include instructions for deriving inferences from user activity regarding content items on a user device. The classification logic can take many different forms depending on the mechanism used to identify and classify content or the nature of the content. For example, the classification logic might include training data used to train a neural network that is used to evaluate content items to determine labels or index entries. The classification logic may comprise fuzzy logic, neural network, finite state machine, support vector machine, logistic regression, clustering, topic modeling, or machine learning techniques, similar statistical classification processes or, combinations of these to identify and classify content items.

Classification logic 252 may be utilized in conjunction with presentation logic 255 (described below). In some embodiments, classification logic 252 may include suggested, or default, classification categories for content classifier 260 or content indexer 264, and suggested, or default, user devices and storage information that may be accessed by content crawler 262. Additionally, classification logic 252 may include explicit categories and indexing “rules,” but may also include inferred indexing categories based on a user's previous indications of categories, and may even be based on other users' previous indications of categories, as described below.

In some embodiments, content classifier 260 (or a subcomponent) determines one or more non-mutually exclusive labels or index entries for a content item, and may further determine a corresponding probability or statistical confidence for a label or index entry, which may be represented as a classification probability score. The classification probability score indicates a likelihood that a content item is correctly classified according to the label or index entry and maybe utilized for scenarios where a particular content item has two or more labels and the particular presentation outcome (i.e., whether and how to conceal or reveal the content item) is conflicting. For example, suppose presentation logic 255 (described below) or other presentation rules for concealing or revealing content specify that content items with label A should be hidden, but content item with label B should be revealed and highlighted. Suppose further that a particular content item includes both labels A and B. Then according to one embodiment, the classification probability scores corresponding to the labels A and B may be used to determine which label more strongly characterizes the particular content item and thus which presentation outcome should be invoked. For instance, if label A has a 51% confidence, but label B has a 95% confidence, then whatever presentation outcome is specified to label B should be used instead of the presentation affect corresponding to label B. (It is also contemplated that there may me presentation logic addressing specific combinations of labels or specifying conflict resolution instructions for conflicting presentation outcomes. For example, in one embodiment, the presentation logic 255 (further described below) may default on the side of hiding a content item rather than promoting it, where there is a conflict because of the labels. In this way, the user's privacy is preserved. In some instances, a user may be notified and prompted to address the conflict.)

In some embodiments, classification logic 252 may be determined based on explicit user configurations, which may include user-defined rules and labels, pre-defined or default rules, such as pre-configured settings (for instance, a default setting may specify that game apps and videos should be indexed or labeled as “entertainment” or that content items containing financial data or personally identifiable data should be indexed as “sensitive” and/or “financial”). Classification logic 252 (as well as presentation logic 255, as described herein) also may be inferred based on information determined from user context determiner 230. For example, where it is observed that a user has hidden, rearranged, or otherwise manipulated content items or the presentation of content on their user device during a particular context, or similarly, where a pattern of such activity is observed, then aspects of classification logic 252 (and/or presentation logic 255) may be inferred based on this observed activity.

In some embodiments, a user may be prompted to confirm the particular inferred classification logic 252 (or presentation logic 255). For example, suppose that several times when a user gives a presentation using his user device, he hides icons of files and applications that clutter his desktop by moving them into a temporary folder so that his desktop appears clean and organized. Following user context determiner 230 observing this behavior, the next time the user is in a similar context (or predicted to be in a similar context), the user may be prompted with a query such as “I notice you hide the icons on your desktop before giving a presentation, do you want me to make this a rule so that every time you give a presentation using any of your devices, the desktop (or home screen) icons are hidden?” Alternatively, aspects of classification logic 252 (or presentation logic 255) may be automatically generated based on observed user activity, without necessarily prompting the user for confirmation. Continuing this example, in some embodiments, as a result of the observed user behavior or explicit user feedback in response to the prompt, classification logic 252 may apply a particular label or index entry (or generate a new label or entry) for icons and other content items on the desktop or home screen. Similarly, presentation logic 255 (further described below) may apply or generate new rule for hiding these content items when the context indicates the user is or soon will be presenting.

In this way, the classification logic 252 (and presentation logic 255) are personalized with regard to a particular user. Thus, a particular classification of a user's content items, which may be represented by a set of metadata (as described herein), also may be personalized with regard to the user. Accordingly, it is contemplated that the specific content-item labels or index for a first user may different than the labels or index for a second user. For instance, for a first user, games or videos (content items) on a user device of the first user may be labeled (according to classification logic 252) as “entertainment” and may be hidden when the current context indicates the user is at work. But for a second user who works in entertainment industry, the same games or video content items may classified as work-related content and therefore may not be hidden (or may be even highlighted) when the current context indicates the second user is at work.

In some embodiments, classification logic 252 may be learned from other users, which may include other similar users. This learned logic may include rules that are explicitly defined by other users (such as user configurations of other users specifying to hide a gambling app when the current context indicates that user is at work) or implicit rules (which may be determined based on monitoring the user activity of another user, as described above for the primary user). In this way, as new content types are developed and/or new content evolves, embodiments of the technologies described herein can adapt and continue to provide the control and benefits that a user desires. For example, where it is determined that another user (or a plurality of other users) are defining a custom label or index entry for a particular new app (such as a new dating app or gambling app), and a primary user has installed that app, then the label may be applied to the primary user's app or may be suggested to user. (Similarly, where it is determined that aspects of presentation logic 255 are being defined for other users, then those aspects may be applied to the primary user's user devices or suggested to the primary user for similar content items and contexts.)

In one embodiment, the classification performed by content classifier 260, or its subcomponents, may be performed in conjunction with the file indexing operations, carried out by the operating system of a user device, for local or desktop file-searching. Content indexer 264 or content classifier 260 may store the determined metadata content index as classified content data index 244 in user profile 240.

Example system 200 also includes storage 250. Storage 250 generally stores information including data, computer instructions (e.g., software program instructions, routines, or services), logic, profiles, and/or models used in embodiments described herein. In an embodiment, storage 250 comprises a data store (or computer data memory). Further, although depicted as a single data store component, storage 250 may be embodied as one or more data stores or may be in the cloud.

As shown in example system 200, storage 250 includes presentation logic 255, as described below, and user profile 240. One example embodiment of a user profile 240 is illustratively provided in FIG. 2. Example user profile 240 includes information associated with a particular user such as user context information 242 (from user context determiner 230), classified content data 244 (i.e., the content metadata determined from content classifier 260), information about user accounts and devices 246, and user preferences 248. The information stored in user profile 240 may be available to the conceal/reveal inference engine 270 and other components of example system 200.

As described previously, user context information 242 generally includes information describing the overall state of the user, which may include information regarding the user's device(s), the user's surroundings, activity events, related contextual information, activity features, or other information determined via user context determiner 230, and may include historical or current user activity information. User accounts and devices 246 generally includes information about user devices accessed, used, or otherwise associated with a user, and/or information related to user accounts associated with the user; for example, online or cloud-based accounts (e.g., email, social media) such as a Microsoft® Net passport, other accounts such as entertainment or gaming-related accounts (e.g., Xbox live, Netflix, online game subscription accounts, or similar account information), user data relating to such accounts such as user emails, texts, instant messages, calls, other communications, and other content; social network accounts and data, such as news feeds; online activity; and calendars, appointments, application data, other user accounts, or the like. Some embodiments of user accounts and devices 246 may store information across one or more databases, knowledge graphs, or data structures. As described previously, the information stored in user accounts and devices 246 may be determined from user-data collection component 210 or user context determiner 230 (including one or more of its subcomponents).

User preferences 248 generally include user settings or preferences associated with the user, and specifically may include user settings or preferences associated with the conceal/reveal inferences engine 270. By way of example and not limitation, such settings may include user preferences about specific content or content categories that the user desires to be revealed or concealed given certain user contexts. The user may specify which data or content should be included for use with the conceal/reveal inferences engine 270, and may also specify custom labels or categories for use by the content classifier 260. In one embodiment, preferences 248 may include user-defined rules for concealing or revealing specific content based on a context; for instance, hiding specifically designated files (or content having a certain label) when the context indicates the user is at a place that is neither work nor home. Further, a graphical user interface may facilitate enabling the user to easily create, configure, or share these user-preferences. For example, in one embodiment, right-clicking on (or touching, or otherwise selecting) a particular content item may invoke a menu, a rules wizard, or other user interface that enables the user to specify treatment (i.e., whether to hide to highlight and according to which context) of that particular content item or similar content items. The user preferences may also include suggested or automatically determined categories as well, based on user context information 242.

In some embodiments, user preferences 248 may contain certain defined modes of operation. These modes of operation may include, for example, a static (or hide) mode, a dynamic mode (based on user context), a substitution mode, and/or an affective mode. The static mode might specify, for example, that all games are to be concealed on a user device while the user is at work. Or, as another example, the static mode might specify that all notifications should be concealed while the user device is in presentation mode. The dynamic mode uses the user context information (such as from user context information 242). As an example, the dynamic mode might specify that all irrelevant notifications should be concealed while the user is in a work meeting, but that such notifications are revealed (presented) during a meeting if they are from other users who were invited to the meeting. The substitution mode might be used in conjunction with the dynamic mode, and could specify, for example, how information that was revealed should be presented. As an example, the substitution mode could specify that any “holes” potentially left by concealed content should be “filled.” The substitution mode might therefore be used, as an example, to make less apparent the fact that certain information has been concealed, such as by replacing concealed content items with similar, revealed content items or rearranging revealed content items to eliminate the holes. The affective mode operates somewhat similarly, but could be used to highlight, or surface, particular information to create an intended effect, based on the user context. As an example, a user might wish to surface other contacts of a user when the user is present at a certain company (to indicate knowledge or buy-in from others at the certain company, for example). As another example, a recent documents list might be re-ranked or reorganized, or an email list manipulated to achieve a desired effect.

Storage 250 also contains conceal/reveal presentation logic 255, as noted above. In some embodiments, presentation logic 255 may include rules, associations, conditions, prediction and/or classification models, or pattern inference algorithms that are used to determine whether certain information should be hidden, or presented. The presentation logic 255 can take many different forms. For example, some embodiments may be used by conceal/reveal inference engine 270, content handler 220, or other components of system 200 to access the user preferences 248 in determining whether certain information should be revealed, or concealed. In other embodiments, the conceal/reveal presentation logic may employ machine learning mechanisms to determine user context similarity and apply the same presentation logic to similar user contexts. Or, in some embodiments, for example, the presentation logic 255 may apply any of the modes of operation discussed above, or specified according to user preferences 248. The presentation logic 255 may also include rules, associations, conditions, prediction and/or classification models, or pattern inference algorithms that are used to determine whether certain information should be substituted for concealed information, or whether (and how) presented information should be restructured, reorganized or otherwise manipulated so as to obscure the fact that other information has been concealed.

As noted above, example system 200 includes a conceal/reveal inferences engine 270. Conceal/reveal inferences engine 270 uses the current user context (such as determined by user context monitor 230 and stored in user context information 242) and the metadata or classified content data index 244 along with the conceal/reveal presentation logic 255. The conceal/reveal inferences engine 270 uses this input to make a determination on whether and how to conceal or reveal (present) information on a user device. The conceal/reveal inferences engine 270 also accesses user preferences 248 (or conceal/reveal presentation logic 255) to determine whether information should be substituted for concealed information, or whether the presentation of information should otherwise be altered to obscure the concealing of information. Additionally, conceal/reveal inferences engine 270 also accesses user preferences 248 (or conceal/reveal presentation logic 255) to determine whether, in addition to presenting certain information, that other information should be highlighted or surfaced in a manner that heightens attention to the information.

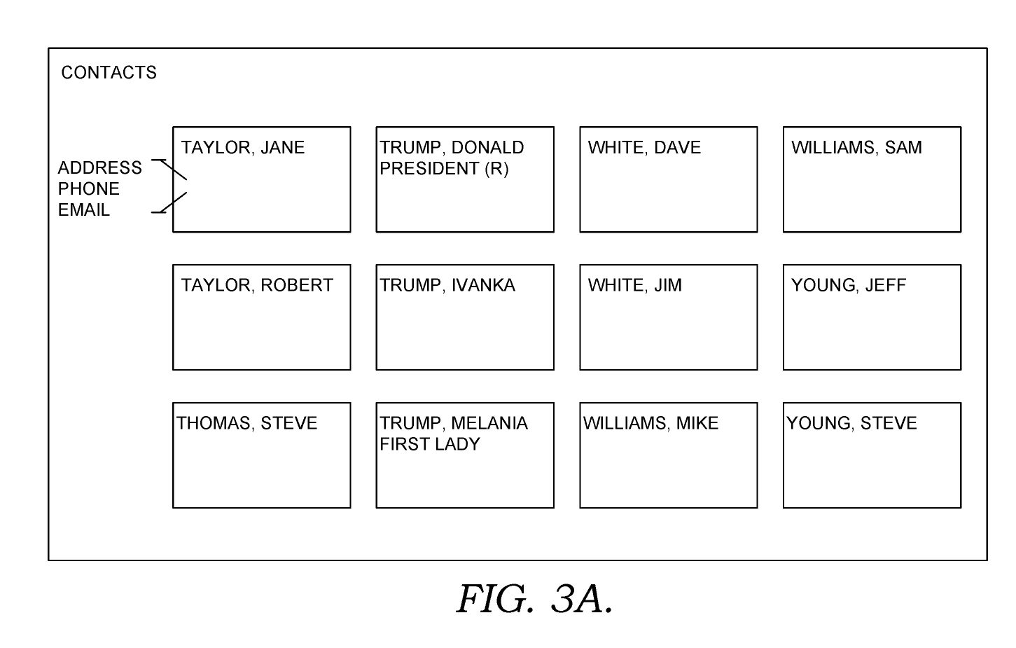

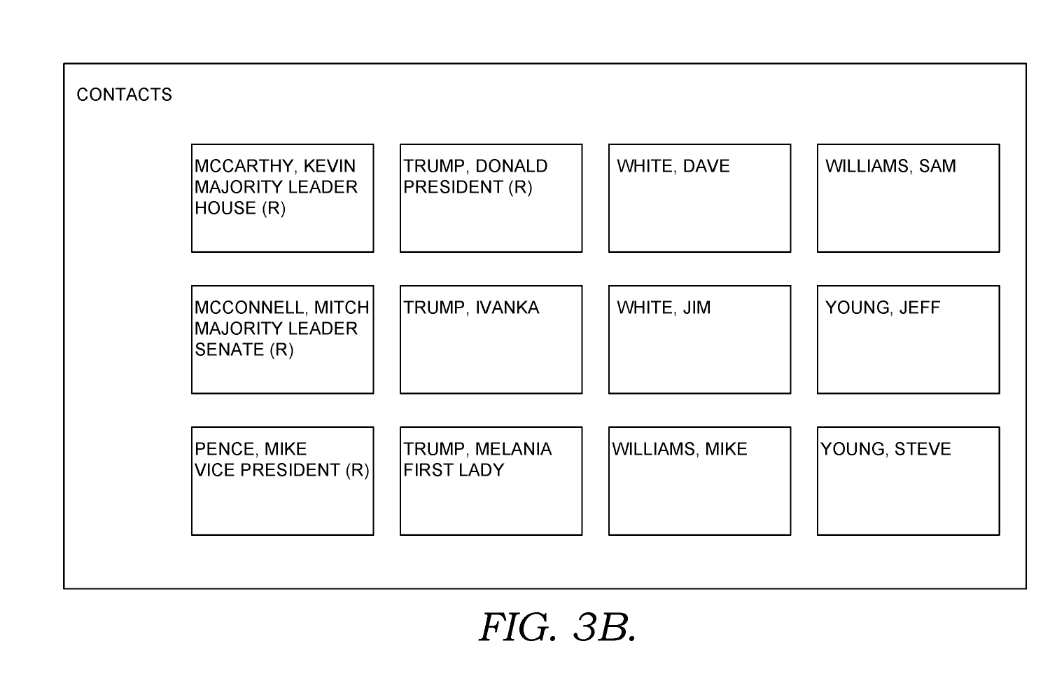

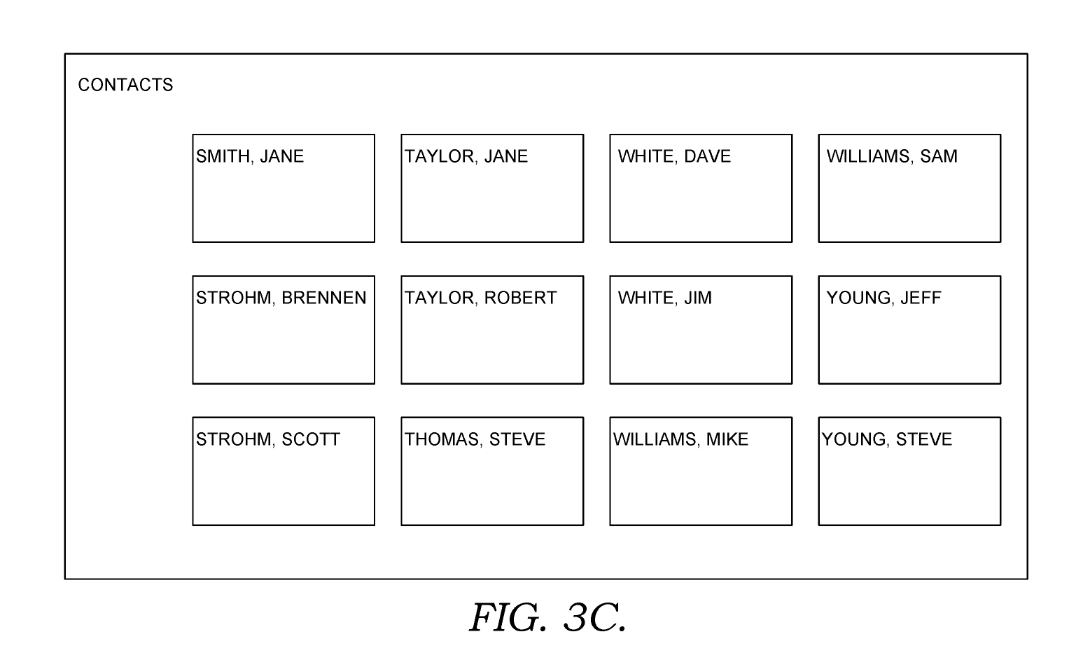

Example system 200 also includes content handler 220 that is generally responsible for presenting content and related information to a user, such as the content determined to be revealed by conceal/reveal inference engine 270. The content may be presented via one or more presentation components 516, described in FIG. 5. Content handler 220 may comprise one or more applications or services on a user device, across multiple user devices, or in the cloud. For example, in one embodiment, content handler 220 manages the presentation of content to a user across multiple user devices associated with that user. Content handler 220 may determine on which user device(s) content is presented, and presents information determined by conceal/reveal inferences engine 270 to be revealed. Content handler 220 presents this information, including any substitutions, reorganizations, or highlights as directed by the conceal/reveal inference engine 270. As only one example, for illustrative purposes, assume that a user is a lobbyist for an organization in the United States, who interacts regularly with members of both the Republican and Democratic parties. A representative portion of the user's contacts is shown in somewhat schematic form in FIGS. 3A-3C. Note that the contacts as shown in FIG. 3A specifically list contact names, but that other contact information that would normally be shown is omitted for simplicity. As the contacts in FIG. 3A show, the user's contacts include information for President Donald Trump, Ivanka Trump, and Melania Trump, among less-notable others. Content classifier 260, might, in this example, categorize the Donald Trump contact as work-related, and also as a Republican contact. The content classifier 260 might also classify the Ivanka Trump and Melania Trump contacts as work-related, or as related to the Donald Trump contact, or as Republican contacts. This classification may be made based on personal meta data of the user based on user patterns of interactions or based on information or global knowledge extracted from external sources, such as the internet, for example. Assume now that the lobbyist user is visiting another Republican contact, such as a House or Senate member. User context determiner 230 may operate to determine, and output to user context information 242, that the user is meeting with a Republican. The conceal/reveal inference engine 270 may then operate to determine whether any presentation logic 255 exists relevant to that determination. Assume that the presentation logic 255, possibly inferred from other users, or possibly from user preferences 248, for example, indicates that in meeting with Republicans, information should be revealed for any Republican contacts. So, as shown in FIG. 3B, the contact information for Donald Trump would be presented. Assume also that the presentation logic 255, possibly inferred from other users, or possibly from user preferences 248, for example, indicates that in meeting with Republicans, information should also be revealed for any contacts related to Republicans. So, as shown in FIG. 3B, the contact information for Ivanka and Melania Trump is also shown. It could also be the case that presentation logic 255 or user preferences 248, for example (such as in an affective mode), indicates that in meeting with Republicans, any Republican contacts above a certain level (such as a Senator, or Cabinet Member) should be highlighted. So, as shown in FIG. 3B, rather than listing contacts Jane Taylor, Robert Taylor, and Steve Thomas, contact information for Kevin McCarthy (Majority Leader in the House of Representatives), Mitch McConnell (Majority Leader in the Senate), and Vice President Mike Pence are surfaced instead (potentially indicating increased Republican influence by the user lobbyist).

Assume now that instead the lobbyist user is visiting a Democratic contact, such as a House or Senate member. User context determiner 230 could operate to determine, and output to user context information 242, that the user is meeting with a Democrat. The conceal/reveal inference engine 270 may then operate to determine whether any presentation logic 255 exists relevant to that determination. Assume that the presentation logic 255, possibly inferred from other users, or possibly from user preferences 248, for example, indicates that in meeting with Democrats, information should be concealed for any Republican contacts. So, as shown in FIG. 3C, the contact information for Donald Trump would be concealed. Assume also that the presentation logic 255, possibly inferred from other users, or possibly from user preferences 248, for example, indicates that in meeting with Democrats, information should also be concealed for any contacts related to Republicans. So, as shown in FIG. 3C, the contact information for Ivanka and Melania Trump is also concealed. It may also be the case that presentation logic 255 or user preferences 248, for example (such as in a substitution mode), indicates that in meeting with Democrats, any remaining contacts should be rearranged to obscure the fact that Republican contacts were concealed. So, as shown in FIG. 3C, additional (non-political) contacts are presented, such that there are no noticeable holes or gaps in the display of the contacts. As the user moves between locations, or meetings, for example, the conceal/reveal inferences engine 270 operates (with content handler 220) to dynamically change the user display in a seamless way to reveal or conceal information as the user context changes. It should be understood that this is only one example, and that an unlimited number of other situations exist depending upon user context, user preferences, and the information at issue.

Turning to FIG. 4, a method 400 for controlling the presentation of content on one or more user devices is shown. As shown at block 402, the method 400 includes receiving a set of personalized metadata characterizing one or more content items that are presentable on a user device. The content item could include, for example and without limitation, one or more files, folders, applications, emails, images video, audio, multimedia, icons, menus, or indications of other content items. Additionally, the content items could include a plurality of content items, and at least a portion of this plurality of content items could be stored at a remote location from the user device. The received metadata could include, for example, one or more labels, where each label classifies some aspect of the content item, and in some aspects, at least one aspect is classified with respect to the user. The received metadata could also include, for example, an index that classifies aspects of each content item, where at least one aspect is classified with respect to the user.

The method could also include, for example, first determining a set of metadata characterizing content items. This determination could include, for example, identifying one or more content items from a set of content items in memory on or accessible by the one or more user devices. For each identified content item, the method could include determining a set of data related to the content item (such as, for example, a file name, file type, the sender, the author, the date, or other data related to the content item). The method could then include analyzing the content item or set of related data to determine one or more features that characterize aspects of the content item or related data. These features that characterize each content item could include, for example and without limitation, information indicating: the content item is related to work, entertainment, a project, a client, a company or organization, another user or contact, a team or group, a genre or a theme; a topic, date, person, location, object, entity, or event determined from the analysis of the content; a creation/modification date or age of the content item, file name, source or author; that the content item contains sensitive (e.g., financial or personally identifiable) information; information indicating the type of content item (e.g., application, document, email, search history item); and/or a rating of the content, such as explicit, safe-for-work, for children, or other designations. The features that characterize the content item could also include user-defined labels or categories, or could be learned based on the behavior of the user, or other similar users. The determined features can then be associated with the content item to create a set of metadata characterizing the one or more content items.

The method 400 also includes, as shown at block 404, receiving (such as from user activity detector 232, or sensor 103a) user-activity related information. The method 400, as shown at block 406, includes monitoring the user-activity related information to determine a current context associated with the user device. The determined current context could include, for example: information indicating user activity associated with a user of the device; other people in proximity (or likely to be in proximity) to the user device; the relationship to the user of people in proximity to the user device; a location (or venue) of the user device; a likelihood that the user device is stolen or in use by an unauthorized user; information about the present user of the user device; information indicating whether the present user is an adult or child (age of the user); information indicating whether the present user is the owner of the user device; a current project the user is working on; a topic related to the user's current activity, or other similar types of information indicating the context of the user.

As shown at block 408, the method includes monitoring instructions to present a first content item on the user device. The instructions could include, for example, requests from a user or computer instructions from the user device, which may result from real-time activity or events, such as incoming communication to the user device, incoming file transmissions, or applications being installed.

At block 410, the method includes determining whether to modify the instructions to present the first content item based at least on the determined current context (from block 406) and the set of received metadata (from block 402). In some aspects, this determination is made according to presentation logic (such as presentation logic 255). As described above, this logic includes rules that specify criteria for controlling the presentation of a content item. These criteria can include rules for hiding (concealing), highlighting, surfacing, positioning, or prioritizing the content item, or substituting a different content item, for example. The positioning or substituting rules can also define the positioning and presentation of the different content item, relative to the first content item. The logic could also include substitution logic that determines the substituted content item based on substitution logic and the set of metadata. As one example, the logic could identify a second content item similar to the first content item, based on the metadata (such as, for example, if the first content item is an app or a video/image, then the logic would find a second, different app or video/image). The criteria noted above could also include rules inferred based on historic user activity of the user device(s). The presentation logic could also include, for example, user settings or preferences configurable by the user.

The method 400 includes, at block 412, generating a set of modified instructions for presenting the first content item. The modified instructions can be generated, by, or based on, for example, the presentation logic described above.

At block 414, the method 400 includes presenting the content item on the user device according to the set of modified instructions for presenting the first content item. The method could also include, for example, continued monitoring of the user-activity related information for any changes in user context. As the user context changes, the method could include determining whether any further modifications to the instructions for presenting are indicated by the presentation logic, and if so, generating a set of updated modified instructions and presenting the content on the user device according to the updated modified instructions.

Accordingly, we have described various aspects of technology directed to systems and methods for improving user privacy and providing user control over the user-activity related data collected from personal computing devices. It is understood that various features, sub-combinations, and modifications of the embodiments described herein are of utility and may be employed in other embodiments without reference to other features or sub-combinations. Moreover, the order and sequences of steps shown in the example method 400 are not meant to limit the scope of the present disclosure in any way, and in fact, the steps may occur in a variety of different sequences within embodiments hereof. Such variations and combinations thereof are also contemplated to be within the scope of embodiments of this disclosure.

Having described various implementations, an exemplary computing environment suitable for implementing embodiments of the disclosure is now described. With reference to FIG. 5, an exemplary computing device is provided and referred to generally as computing device 500. The computing device 500 is but one example of a suitable computing environment and is not intended to suggest any limitation as to the scope of use or functionality of embodiments of the disclosure. Neither should the computing device 500 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the disclosure may be practiced in a variety of system configurations, including handheld devices, consumer electronics, general-purpose computers, or more specialty computing devices. Embodiments of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 5, computing device 500 includes a bus 510 that directly or indirectly couples the following devices: memory 512, one or more processors 514, one or more presentation components 516, one or more input/output (I/O) ports 518, one or more I/O components 520, and an illustrative power supply 522. Bus 510 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 5 is merely illustrative of an exemplary computing device that can be used in connection with one or more embodiments of the present disclosure. Distinction is not made between such categories as “workstation,” “server,” “laptop,” or “handheld device,” as all are contemplated within the scope of FIG. 5 and with reference to “computing device.”

Computing device 500 typically includes a variety of computer-readable media. Computer-readable media can be any available media that can be accessed by computing device 500 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include for example solid-state memory, hard drives, and optical-disc drives. Computing device 500 includes one or more processors 514 that read data from various entities such as memory 512 or I/O components 520. Presentation component(s) 516 presents data indications to a user or other device. Exemplary presentation components include a display device, speaker, printing component, vibrating component, and the like.

The I/O ports 518 allow computing device 500 to be logically coupled to other devices, including I/O components 520, some of which may be built in. Illustrative components include a microphone, joystick, game pad, satellite dish, scanner, printer, or a wireless device. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

Some embodiments of computing device 500 may include one or more radio(s) (or similar wireless communication components). The radio transmits and receives radio or wireless communications. The computing device 500 may be a wireless terminal adapted to receive communications and media over various wireless networks. Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computing system for controlling the presentation of content on one or more user devices, comprising:
one or more sensors configured to provide sensor data including user-activity related information;
one or more processors; and
computer storage memory having computer-executable instructions stored thereon which, when executed by the processor, implement a method for controlling the presentation of content on the computing device, the method comprising:
receiving a set of personalized metadata characterizing one or more content items that are presentable on a user device;
receiving, from the one or more sensors, user-activity related information;
monitoring the user-activity related information to determine a current context associated with the user device;
monitoring instructions to present a first content item on the user device;
determining to modify the instructions to present a first content item based at least on the current context and the set of personalized metadata;
generating a set of modified instructions for presenting the first content item; and
presenting the first content item on the user device according to the set of modified instructions for presenting the first content item.

2. The system of claim 1, wherein the method further comprises:
determining a change in the current context based upon monitoring the user-activity related information;
determining to further modify the modified instructions for presenting the first content item based upon the determined change in the current context;
generating a set of further modified instructions for presenting the first content item; and
presenting the first content item on the user device according to the set of further modified instructions for presenting the first content item.

3. The system of claim 1, wherein the determining to modify the instructions to present the first content item comprises making a determination according to presentation logic, the presentation logic including a set of rules specifying criteria for controlling presentation of a content item.

4. The system of claim 3, wherein the presentation logic includes user settings configurable by the user.

5. The system of claim 4, wherein the criteria for controlling presentation of a content item comprises one of hiding the first content item, surfacing the first content item, positioning the first content item, prioritizing the first content item, or substituting a second content item for the first content item.

6. The system of claim 5, wherein the presentation logic includes substitution logic, and wherein substituting the second content item comprises determining the second content item from the one or more content items based on the substitution logic and the set of personalized metadata.

7. The system of claim 6, wherein the criteria for controlling presentation of a content item are inferred based on user-activity history of the one or more user devices.

8. The computing device of claim 1, wherein the personalized metadata comprises one or more labels, each label classifying an aspect of a content item, and wherein at least one aspect is classified with respect to the user.

9. The system of claim 1, wherein the personalized metadata comprises an index that classifies aspects of each content item, and wherein at least one aspect is classified with respect to the user.

10. A method for controlling the presentation of content on one or more user devices, the method comprising:
receiving a set of personalized metadata characterizing one or more content items that are presentable on a user device;
receiving a current context associated with the user device;
monitoring instructions to present a first content item on the user device;
determining to modify the instructions to present a first content item based at least on the current context and the set of personalized metadata;
generating a set of modified instructions for presenting the first content item; and
presenting the first content item on the user device according to the set of modified instructions for presenting the first content item.

11. The method of claim 10, further comprising:
receiving an updated current context associated with the user device;
determining to further modify the modified instructions for presenting the first content item based upon the updated current context;
generating a set of further modified instructions for presenting the first content item; and
presenting the first content item on the user device according to the set of further modified instructions for presenting the first content item.

12. The method of claim 10, wherein the determining to modify the instructions to present the first content item comprises making a determination according to presentation logic, the presentation logic including a set of rules specifying criteria for controlling presentation of a content item.

13. The method of claim 12, wherein the presentation logic includes user settings configurable by the user.

14. The method of claim 13, wherein the criteria for controlling presentation of a content item comprises one of hiding the first content item, surfacing the first content item, positioning the first content item, prioritizing the first content item, or substituting a second content item for the first content item.

15. The method of claim 14, wherein the criteria for controlling presentation of a content item are inferred based on user-activity history of the one or more user devices.

16. A method for controlling the presentation of content on one or more user devices, the method comprising:
receiving a set of personalized metadata characterizing one or more content items that are presentable on a user device;
receiving user-activity related information;
monitoring the user-activity related information to determine a current context associated with the user device;
monitoring instructions to present a first content item on the user device; and
presenting the first content item on the user device according to the received set of personalized metadata and the current context.

17. The method of claim 16, wherein the presenting includes determining to modify a presentation of the first content item based on presentation logic, the presentation logic including a set of rules specifying criteria for controlling presentation of a content item.

18. The method of claim 17, wherein the presentation logic includes user settings configurable by the user.

19. The method of claim 18, wherein the criteria for controlling presentation of a content item comprises one of hiding the first content item, surfacing the first content item, positioning the first content item, prioritizing the first content item, or substituting a second content item for the first content item.

20. The method of claim 19, wherein the criteria for controlling presentation of a content item are inferred based on user-activity history of the one or more user devices.
